(19) United States
(12) Patent Application Publication
(10) Pub. No.: US 2024/0238923 A1
(43) Pub. Date: Jul. 18, 2024

(54) MACHINE TOOL FOR MACHINING SEMI-FINISHED ALUMINUM OR TITANIUM ALLOY PRODUCTS

(71) Applicant: INNSE-BERARDI S.P.A SOCIETA' UNIPERSONALE, Brescia (IT)

(72) Inventor: Marcello MARCHETTI, Brescia (IT)

(21) Appl. No.: 18/559,425

(22) PCT Filed: Apr. 20, 2022
(86) PCT No.: PCT/IB2022/053695

§ 371 Date: Nov. 7, 2023

(30) Foreign Application Priority Data
May 20, 2021 (IT) 102021000013130
Jun. 23, 2021 (IT) 102021000016484

(51) Int. Cl. B23Q 1/01; B23Q 1/62; B23Q 5/22

(52) U.S. Cl. CPC B23Q 1/01; B23Q 1/62; B23Q 5/22

(57) ABSTRACT

A machine tool for machining semi-finished aluminum or titanium alloy products has a supporting structure, an upright, a carriage and a working head. The supporting structure has a bench and a rear support rigidly connected to each other. The bench extends along a longitudinal direction, while the rear support extends both along the longitudinal direction and along a vertical direction. The supporting structure is provided with upright translation elements. The upright is connected to the supporting structure by the upright translation elements so as to translate along the longitudinal direction and is provided with carriage translation elements. The carriage is connected to the upright by the carriage translation elements so as to be translatable along the vertical direction. The machine tool has a first pair of carriage moving ratio motors and a second pair of carriage moving ratio motors positioned aboard the upright and engaging the carriage translation elements.

The present invention relates to the field of machine tools, and in particular to the technical field of large machine tools, such as a horizontal boring machine or a milling machine or a lathe. In particular, the present invention relates to a machine tool suitable to machine semi-finished aluminum alloy or titanium alloy products.

Such machine tools are used to carry out mechanical machining on large semi-finished products for the aeronautical, aerospace and naval industries.

Due to the criticality of such industrial applications, extremely low machining tolerances are generally required. Machine tool manufacturers are therefore constantly engaged in the research and development of solutions which may guarantee these tolerances.

In the case of semi-finished titanium alloy machining, it is observed that, during the chip removal operations, the tool develops vibrations with a frequency of between 12 and 18 Hz. Considering that the resonant frequency of machine tools according to the prior art is between 14 and 16 Hz, it is clear to those skilled in the art that the machining of titanium alloys produces vibrations in the resonance range of the machines, which in fact prevent the tolerances required by the industrial applications for which the finished piece is intended from being obtained.

On the other hand, in the case of machining of semi-finished aluminum alloy products, compliance with dimensional tolerances requires very long production times. It is clear that, by increasing the rigidity of the machine and increasing the value of the first resonant frequency, the dynamic performance of the machine tool would improve and consequently the production times could be reduced without compromising the respect of the required tolerances.

Therefore, in order to comply with tolerances and/or improve dynamic performance, machine tools should be rigid enough to guarantee a resonant frequency of between 23 and 30 Hz.

So far, the efforts made by manufacturers have been aimed at increasing the rigidity of the machines. While it is possible to improve the stiffness through an increase in the stiffness of the machine structures, this technical prejudice, however justified by structural science, has not so far produced any satisfactory results.

The object of the present invention is to provide a large-sized machine tool capable of obviating the drawbacks mentioned above.

Such object is achieved with a machine tool for machining semi-finished aluminum alloy or titanium alloy products according to the appended claim 1. The claims dependent thereon identify additional advantageous embodiments of the invention.

The features and the advantages of the machine tool according to the present invention shall be made readily apparent from the following description of preferred embodiment examples thereof, provided purely by way of a non-limiting example, with reference to the accompanying figures, in which:

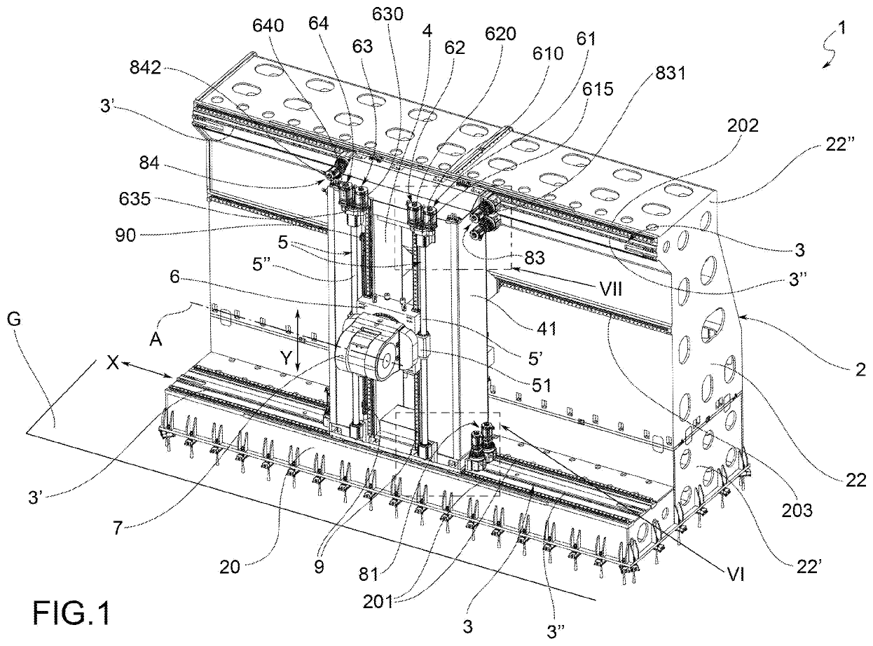

FIG. 1 is a perspective view of a machine tool in one embodiment;

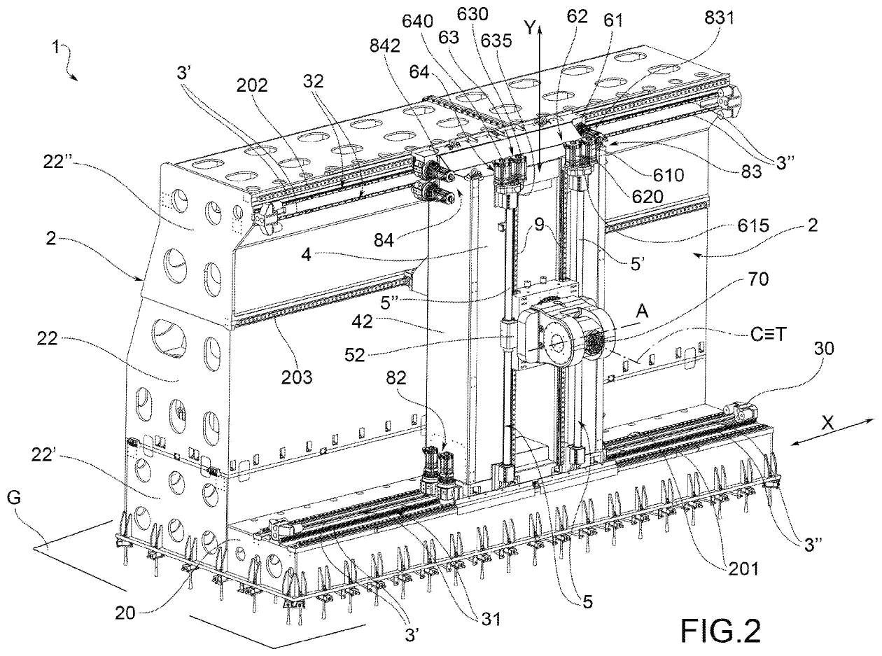

FIG. 2 is a perspective view of the machine tool of FIG. 1 according to a different angle;

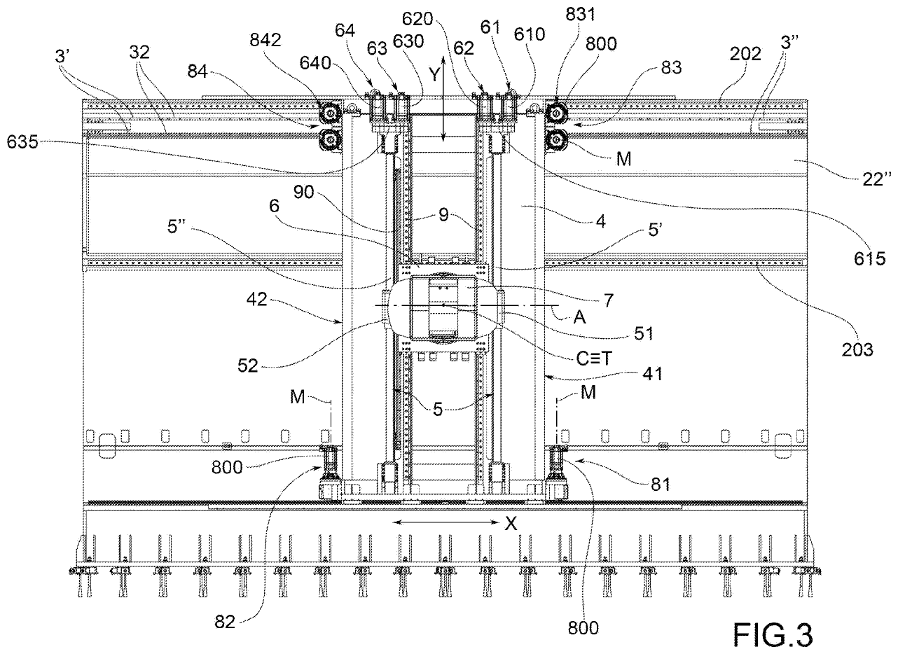

FIG. 3 is a front view of the machine tool of FIG. 1;

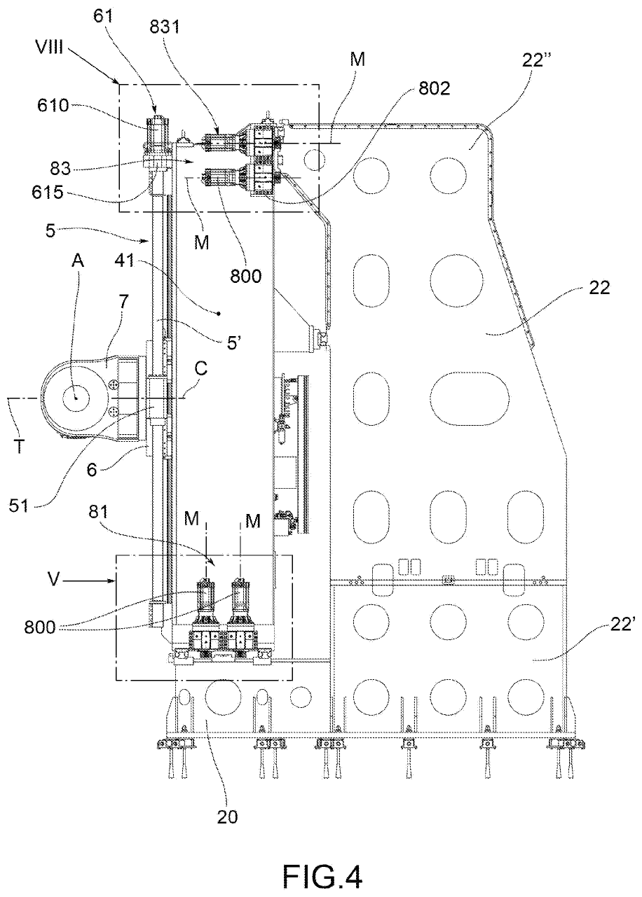

FIG. 4 is a side view of the machine tool of FIG. 1;

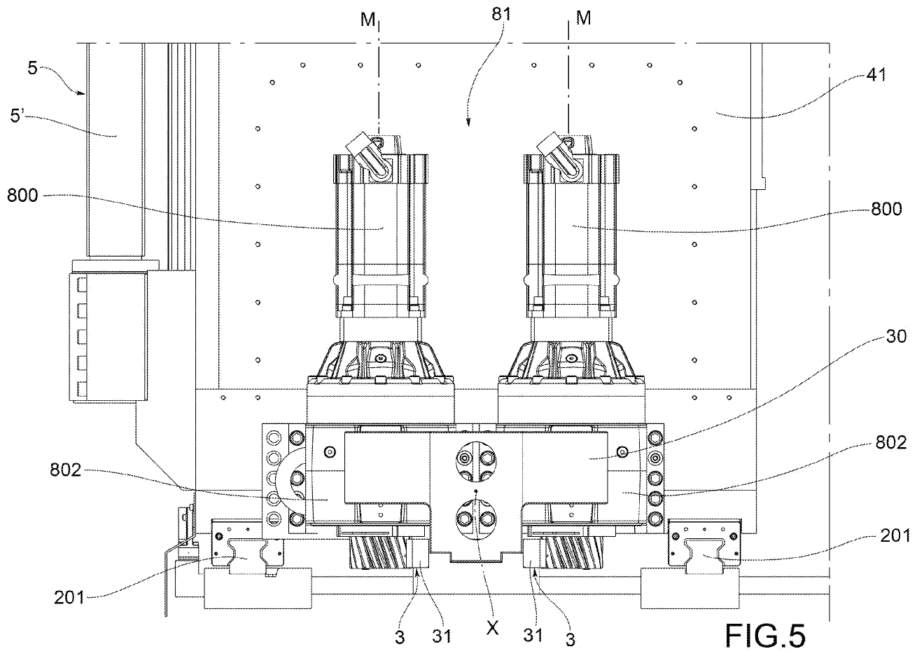

FIG. 5 is an enlarged view of the detail V in the square in FIG. 4;

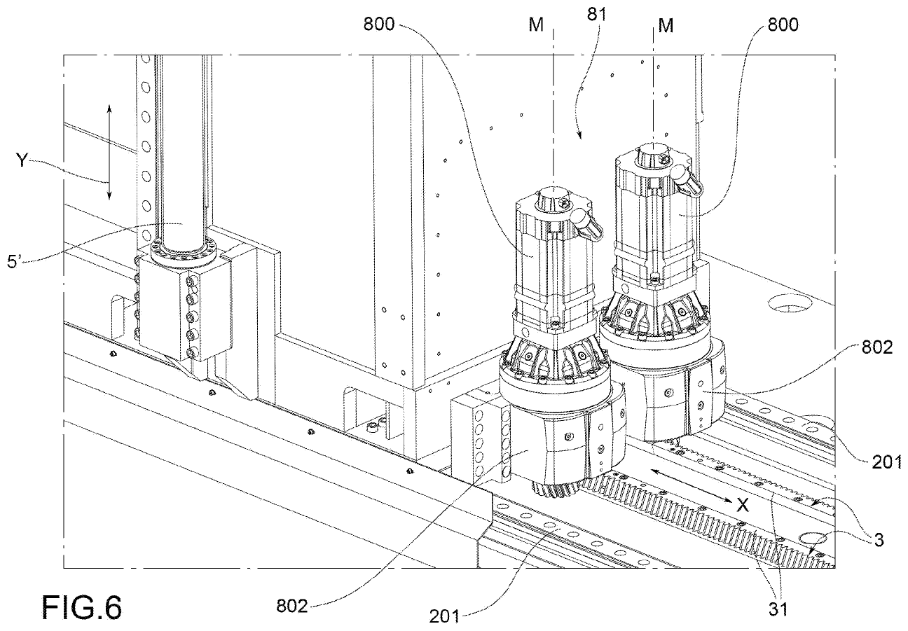

FIG. 6 is an enlarged view of the detail VI highlighted in FIG. 1;

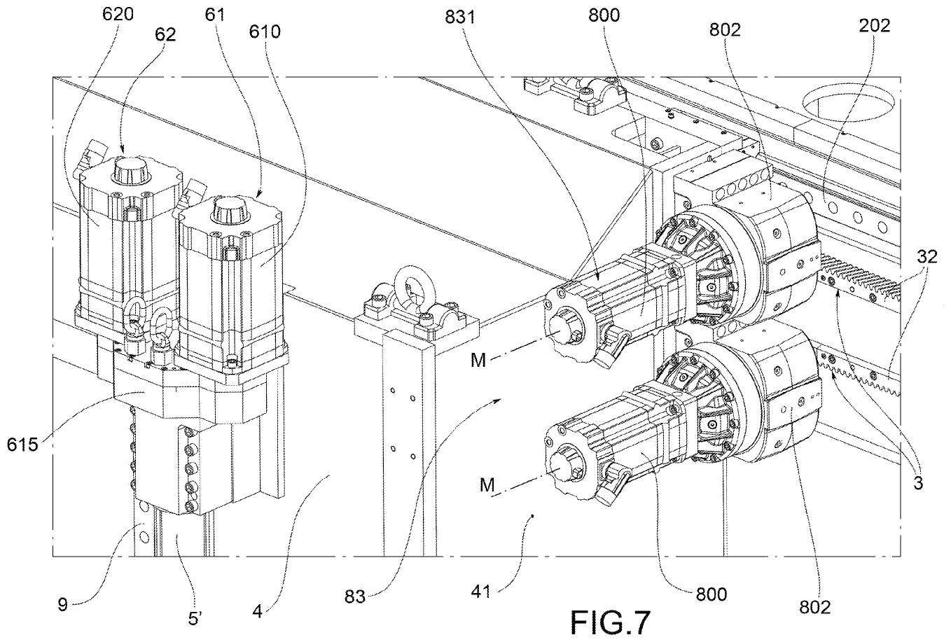

FIG. 7 is an enlarged view of the detail VII highlighted in FIG. 1;

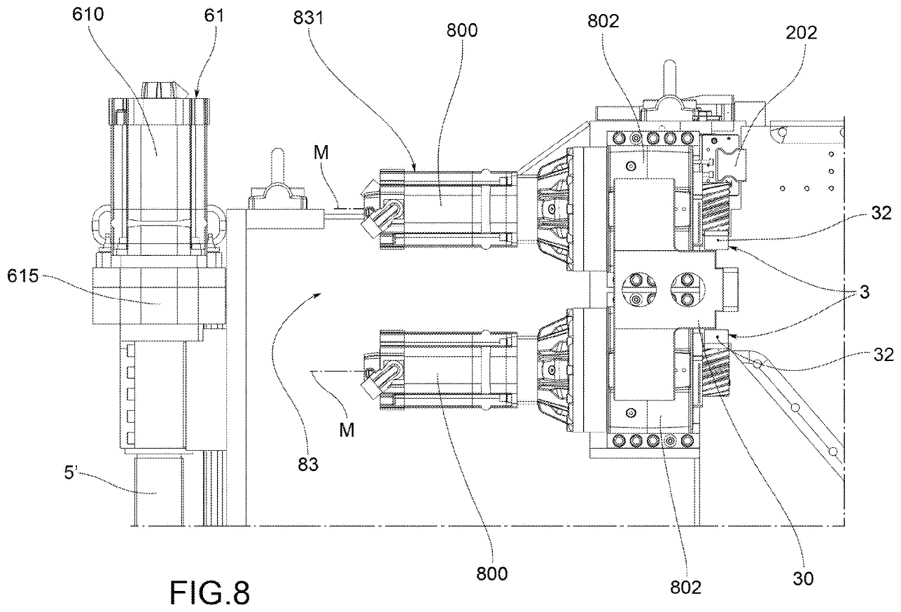

FIG. 8 is an enlarged view of the detail VIII in the square in FIG. 4;

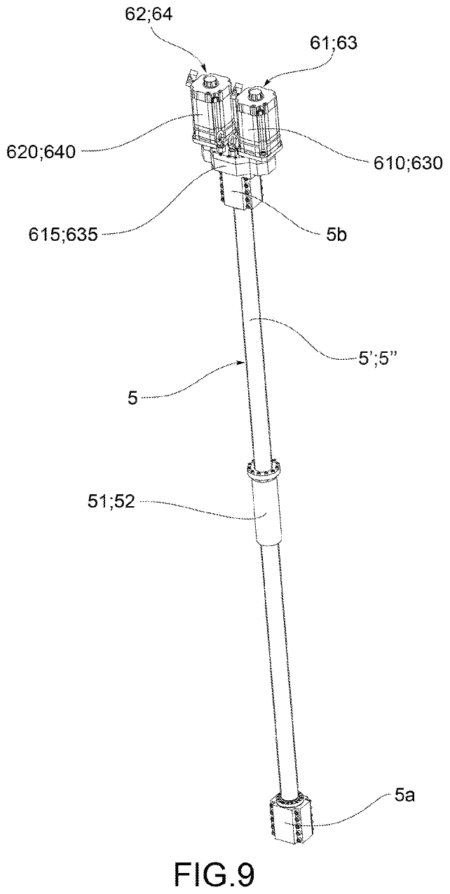

FIG. 9 is a perspective view of carriage translation means operable by a first pair of carriage moving ratio motors or by a second pair of carriage moving ratio motors;

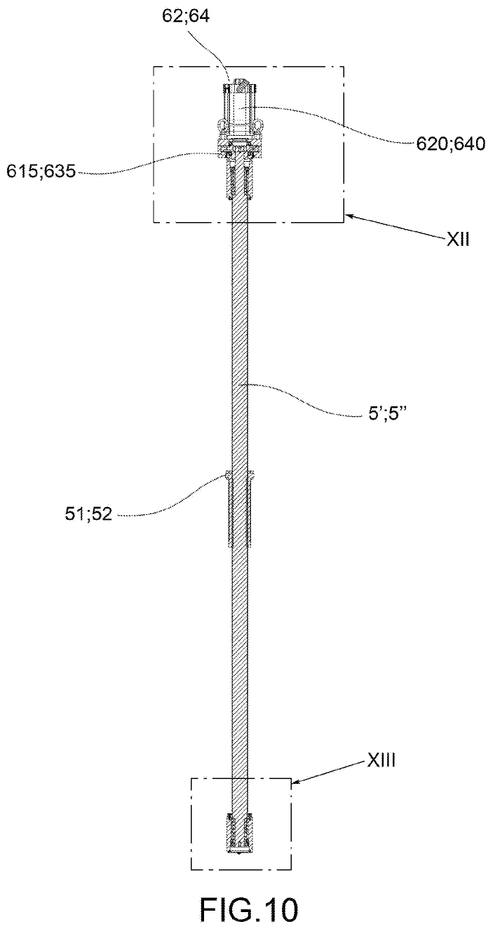

FIG. 10 is a sectional view of the carriage translation means shown in FIG. 9;

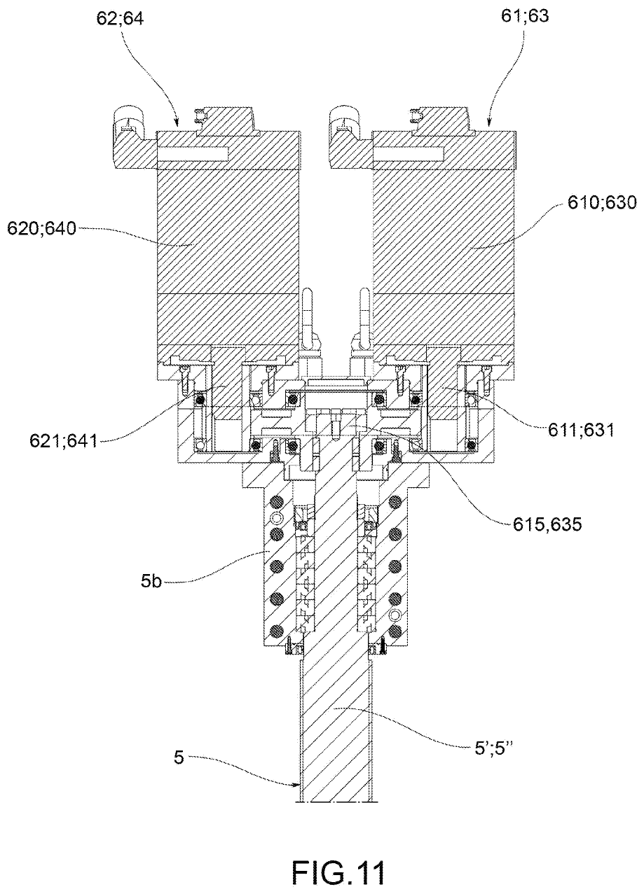

FIG. 11 is a sectional view of an end portion of the carriage translation means operable by the first pair of carriage moving ratio motors or by the second pair of carriage moving ratio motors;

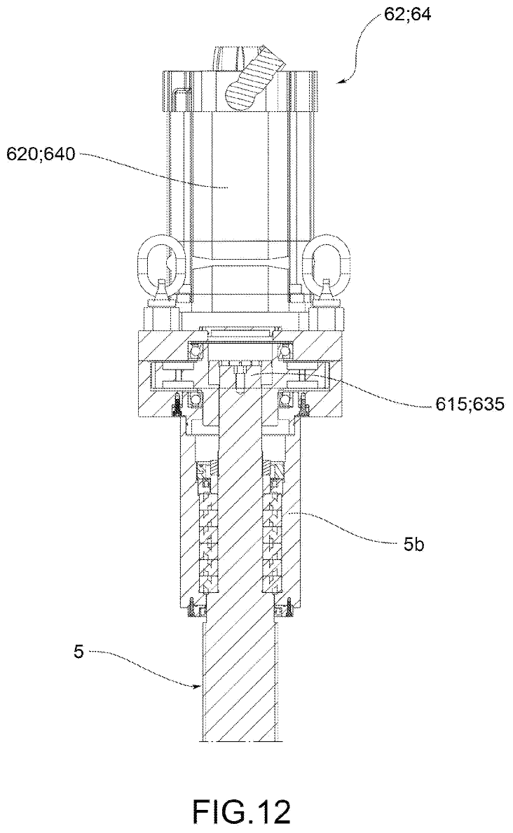

FIG. 12 is an enlarged view of the detail XII in the square in FIG. 10, and

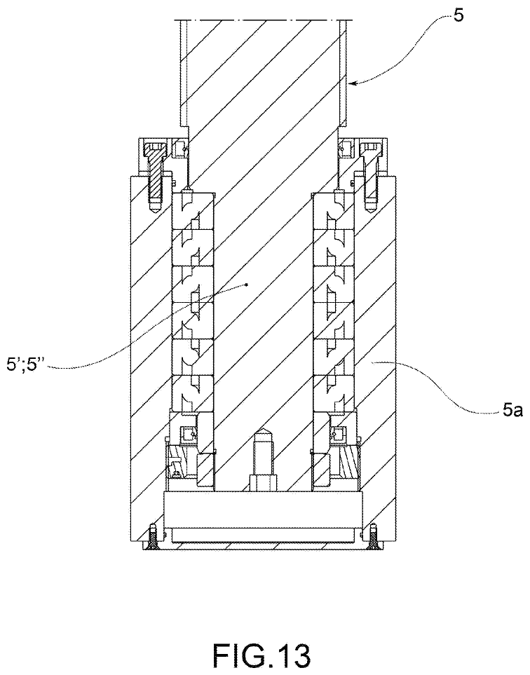

FIG. 13 is an enlarged view of the detail XIII in the square in FIG. 10.

In the following description, elements common to the various embodiments represented in the drawings are indicated with the same reference numerals.

With reference to the figures of the accompanying drawings, the reference numeral 1 generally indicates a machine tool suitable to machine semi-finished aluminum alloy or titanium alloy products.

In a general embodiment, the machine tool 1 for machining semi-finished aluminum alloy or titanium alloy products is designed to rest on a horizontal reference plane G, for example the ground plane. Such machine tool 1 comprises a supporting structure 2, an upright 4, a carriage 6 and a working head 7.

The supporting structure 2 comprises a bench 20 and a rear support 22. The bench 20 has a main extension along a longitudinal direction X, while the rear support 22 extends both along the longitudinal direction X and along a vertical direction Y.

The bench and the rear support are rigidly connected to each other, i.e. engaged and made integral. For example, the bench 20 and the rear support 22 are connected in such a way that the supporting structure 2 has an “L”-shaped cross section, where such cross section is meant to be obtained along a plane orthogonal to the longitudinal direction X.

The supporting structure 2 is also provided with upright translation means 3 oriented according to the longitudinal direction X.

The upright 4 is connected to the supporting structure 2 by means of the upright translation means 3, so as to translate along the longitudinal direction X. Such upright 4 is further provided with carriage translation means 5 oriented according to the vertical direction Y.

The carriage 6 is connected to the upright 4 by means of the carriage translation means 5 so as to be translatable along the vertical direction Y.

The working head 7 is engaged with the carriage 6 and has a tool holder seat 70 suitable to house a tool for chip removal machining.

The machine tool 1 also comprises a first pair of carriage moving ratio motors 61, 62 and a second pair of carriage moving ratio motors 63, 64. Said first 61, 62 and second 63, 64 pair of carriage moving ratio motors are positioned aboard the upright 4 and are engaged with the carriage translation means 5.

In one embodiment, the carriage translation means 5 comprise a first ball screw 5′ and a second ball screw 5″.

According to an embodiment, the first ball screw 5′ is actuated by the first pair of carriage moving ratio motors 61, 62 whereas the second ball screw 5″ is actuated by the second pair of carriage moving ratio motors 63, 64.

Preferably, the first ball screw 5′ is provided with a first nut 51 and the second ball screw 5″ is provided with a second nut 52. In particular, these first 51 and second 52 nut are connected to opposite sides of the carriage 6, respectively.

For example, considering that the working head 7 is engaged to the carriage 6, the first 51 and the second 52 nut are connected to the carriage 6 so as to be arranged at the sides of the working head 7.

According to an embodiment, the first pair of carriage moving ratio motors 61, 62 comprises a first pair of electric motors 610, 620 and a first gearbox 615, where each electric motor of said first pair of electric motors is provided with a first moving shaft 611; 621 which engages the first gearbox 615. The second pair of carriage moving ratio motors 63, 64 in turn comprises a second pair of electric motors 630, 640 and a second gearbox 635, where each electric motor of said second pair of electric motors is provided with a second moving shaft 631; 641 which engages the second gearbox 635.

Preferably, the first pair of carriage moving ratio motors 61, 62 only comprises the first pair of electric motors 610, 620 and the first gearbox 615, while the second pair of carriage moving ratio motors 63, 64 only comprises the second pair of electric motors 630, 640 and the second gearbox 635.

FIG. 11 illustrates the kinematic chain of engagement between the first (or second) pair of electric motors and the first (or second) gearbox.

According to an embodiment, a main electric motor 630 belonging to the first 61, 62 or to the second pair of carriage moving ratio motors 63, 64 is a master whereas the other three electric motors 610, 620, 640 of the first 61, 62 and second pairs of carriage moving ratio motors 63, 64 are slaves.

Therefore, the actuation of the translation of the carriage 6 along the vertical direction Y is guided by a master-slave architecture.

Preferably, the upright 4 also comprises a pair of vertical guides 9 on which the carriage 6 slides. For example, such pair of vertical guides 9 is a pair of vertical sliding tracks, that is, oriented along the vertical direction Y.

In one embodiment, the machine tool 1 further comprises a vertical position transducer 90, e.g. an optical ruler, for detecting the position of the carriage 6 with respect to the upright 4.

Preferably, the vertical position transducer 90 is associated with a vertical guide of the pair of vertical guides 9.

According to an embodiment, the vertical position transducer 90 is positioned parallel to a vertical guide of the pair of vertical guides 9. Furthermore, such vertical position transducer 90 is arranged along the vertical direction Y, so as to be substantially vertically aligned with the main electric motor 630.

Preferably, both the first 5′ and the second ball screw 5″ comprise a lower support 5a and an upper support 5b. In this case, the lower support 5a is represented in FIG. 13, while the upper support 5b is represented in FIG. 12.

According to an embodiment, the machine tool 1 further comprises four pairs of ratio motors 81, 82, 83, 84 which are positioned aboard the upright 4 and engage with the upright translation means 3.

According to an embodiment shown in the accompanying FIGS. 6 and 7, the upright translation means 3 comprise a first pair of upright translation members 31 fixed to the bench 20 and a second pair of upright translation members 32 fixed to the rear support 22.

According to an embodiment illustrated in the accompanying FIGS. 1 and 2, a first pair of ratio motors 81 and a second pair of ratio motors 82 of the four pairs of ratio motors 81, 82, 83, 84 engage the first pair of upright translation members 31.

Instead, a third pair of ratio motors 83 and a fourth pair of ratio motors 84 of such four pairs of ratio motors 81, 82, 83, 84 engage the second pair of upright translation members 32.

In one embodiment, the first 81 and the third pair of ratio motors 83 are positioned on a first side 41 of the upright 4 whereas the second 82 and the fourth pair of ratio motors 84 are positioned on a second side 42 of the upright 4, opposite to the first side 41.

Said first 41 and second side 42 are lateral with respect to the position of the carriage translation means 5 on which the carriage 6 translates.

According to an embodiment, a first main ratio motor 831 belonging to the first 81 or to the third pair of ratio motors 83 is a master, while the remaining three ratio motors of the first and third pair of ratio motors are slaves. Furthermore, a second main ratio motor 842 belonging to the second 82 or to the fourth pair of ratio motors 84 is a master, while the remaining three ratio motors of the second and fourth pair of ratio motors are slaves.

Preferably, the first main ratio motor 831 belongs to the third pair of ratio motors 83 and is positioned in proximity to an upper end 22″ of the rear support 22. The second main ratio motor 842 belongs to the fourth pair of ratio motors 84 and is positioned in proximity to the upper end 22″.

In particular, both on the first side 41 and on the second side 42 of the upright 4 there is a master-slave architecture.

In one embodiment, each upright translation member of the first 31 and of the second pair of upright translation members 32 is a rack. Furthermore, each ratio motor of each of the four pairs of ratio motors 81, 82, 83, 84 comprises an electric upright translation motor 800 and a gearbox 802. The upright translation electric motor 800 has a motor axis M which is parallel to the vertical direction Y. The gearbox 802 has an inlet engaged with the upright translation electric motor 800 and an outlet engaged with the rack.

The accompanying FIGS. 5-8 illustrate the kinematic chain, where each upright translation member is a rack fixed to the supporting structure and where each ratio motor is fixed aboard the upright 4 and engages with the rack.

Preferably, the inlet and outlet of the gearbox 802 are coaxial to the motor axis M and the outlet comprises a toothed wheel which engages with the rack.

According to an embodiment, a GANTRY control is provided between each master and the respective slaves.

Therefore, a GANTRY control is also provided on both the first side 41 and the second side 42 of the upright 4. Furthermore, a GANTRY control is also provided between the first 61, 62 and the second pair of carriage moving ratio motors 63, 64.

The GANTRY control is implemented on master-slave architectures where, by means of MIMO (Multiple-Input and Multiple-Output) communication, the slave ratio motors follow the positions controlled by the master and send their feedback data to the master, so as to obtain a closed-loop control.

In one embodiment, the working head 7 is rotatable about a pitching axis A and about a rolling axis C.

According to an embodiment illustrated in FIG. 4, the tool holder seat 70 is rotatable about a tool axis T.

It should be noted that, by virtue of the type of machining to be carried out on the semi-finished product, the tool axis T may be collinear or incident with the rolling axis C.

In one embodiment, the bench 20 also comprises a first pair of guides 201 on which the upright 4 slides.

Furthermore, the rear support 22 extends between a lower end 22′ connected to the bench 20, and an upper end 22″ where, at such upper end, the second pair of upright translation members 32 and a second guide 202 on which the upright 4 slides are positioned.

In an embodiment shown in the accompanying FIGS. 1 and 2, at least a third guide 203 which is fixed to the rear support 22 and on which the upright 4 slides is positioned in between the upper end 22″ and the lower end 22′.

Preferably, such third guide 203 is spaced vertically, i.e. along the vertical direction Y, from the second pair of upright translation members 32.

In particular, the first pair of guides 201, the second guide 202 and the third guide 203 are longitudinal sliding tracks, i.e. oriented along the longitudinal direction X.

According to an embodiment, both the first 31 and the second pair of upright translation members 32 extend along the longitudinal direction X between a first end 3′ and a second end 3″ opposite the first 3′. A position transducer 30, for example an optical ruler, is associated with such first 3′ and second 3″ ends.

Innovatively, the machine tool object of the present invention fulfills the intended purpose, as it achieves such a stiffness that the first resonance frequency is comprised in the range between 24 and 30 Hz.

Analytically, following software simulations for finite element analysis (FEA) of the machine tool object of the present invention, it has been calculated that the first resonance frequency is about 30 Hz. Considering that the value obtained is the result of a model that represents a simplification of reality, it was decided in favor of safety to consider 80% of the calculated value. Therefore, the first conservatively calculated resonance frequency is equal to 24 Hz, i.e. 80% of the result obtained through FEA simulations.

Advantageously, the machine tool object of the present invention is more rigid than the machine tools according to the prior art.

Contrary to the technical prejudice, which sought to improve the rigidity of the machines by only increasing the rigidity of the structures, in the present invention the degrees of constraint between the upright and the carriage translation means have been increased.

In addition, the degrees of constraint between the upright and the supporting structure have also been increased.

The increase in stiffness and in the value of the first resonant frequency were achieved when passing from the solution with only two ratio motors engaged with the carriage translation means, contemplated by the prior art, to the present invention in which a first and a second pair of carriage moving ratio motors engaged with the carriage translation means have been introduced. Therefore, the constraint between the upright and the carriage translation means has changed from two to four degrees.

Analytically, it has been observed that the increase in the degrees of constraint between the upright and the carriage translation means produces an increase in the resonance frequency such as to be able to machine the titanium alloys in absolute safety and in compliance with the required tolerances. In other words, it has been observed that by replacing each ratio motor of the prior art with a smaller pair of carriage moving ratio motors, the overall rigidity of the machine increases considerably and its dynamic performances improve.

According to an advantageous aspect, the machine tool object of the present invention is safe, since it operates on frequencies far from the resonant frequency of the machine itself.

According to a still further advantageous aspect, the machine tool object of the present invention has a lower manufacturing cost or comparable with the machine tools according to the prior art.

It is clear that those skilled in the art, in order to satisfy contingent needs, may make modifications to the machine tool described above, or replace elements with other functionally equivalent ones, without however departing from the scope of protection of the following claims. Each of the features described as belonging to a possible embodiment may be obtained independently in the other described embodiments.

1. A machine tool suitable to machine semi-finished aluminum alloy or titanium alloy products and designed to rest on a horizontal reference plane, for example a ground plane, said machine tool comprising:
a supporting structure comprising a bench having a main extension along a longitudinal direction, and a rear support extending both along the longitudinal direction and along a vertical direction, wherein the bench and the rear support are rigidly connected to each other, and wherein the supporting structure is provided with upright translation means oriented according to the longitudinal direction;
an upright connected to the supporting structure by the upright translation means so as to translate along the longitudinal direction, said upright comprising carriage translation means oriented according to the vertical direction;
a carriage connected to the upright by the carriage translation means so as to be translatable along the vertical direction; and
a working head engaged with the carriage and having a tool holder seat suitable to house a tool for chip removal machining,
wherein the machine tool further comprises a first pair of carriage moving ratio motors and a second pair of carriage moving ratio motors, and wherein said first and second pairs of carriage moving ratio motors are positioned aboard the upright and engaged to the carriage translation means.

2. The machine tool of claim 1, wherein the carriage translation means comprise a first ball screw and a second ball screw.

3. The machine tool of claim 2, wherein the first ball screw is actuated by the first pair of carriage moving ratio motors and the second ball screw is actuated by the second pair of carriage moving ratio motors.

4. The machine tool of claim 2, wherein the first ball screw is provided with a first nut and the second ball screw is provided with a second nut, and wherein said first and second nuts are respectively connected to opposite sides of the carriage.

5. The machine tool of claim 1, wherein the first pair of carriage moving ratio motors comprises a first pair of electric motors and a first gearbox, wherein each electric motor of said first pair of electric motors is provided with a first moving shaft that engages the first gearbox, wherein the second pair of carriage moving ratio motors comprises a second pair of electric motors and a second gearbox, and wherein each electric motor of said second pair of electric motors is provided with a second moving shaft that engages the second gearbox.

6. The machine tool of claim 1, wherein a main electric motor belonging to the first pair of carriage moving ratio motors or to the second pair of carriage moving ratio motors is a master and the other three electric motors of the first and second pairs of carriage moving ratio motors are slaves.

7. The machine tool of claim 1, wherein the upright further comprises a pair of vertical guides on which the carriage slides.

8. The machine tool of claim 1, further comprising a vertical position transducer, for example an optical ruler, for detecting a position of the carriage with respect to the upright.

9. The machine tool of claim 1, further comprising four pairs of ratio motors positioned aboard the upright and engaged with the upright translation means.

10. The machine tool of claim 9, wherein the upright translation means comprise a first pair of upright translation members fixed to the bench and a second pair of upright translation members fixed to the rear support.

11. The machine tool of claim 10, wherein a first pair of ratio motors and a second pair of ratio motors of said four pairs of ratio motors engage the first pair of upright translation members and wherein a third pair of ratio motors and a fourth pair of ratio motors of said four pairs of ratio motors engage the second pair of upright translation members.

12. The machine tool of claim 11, wherein the first pair of ratio motors and the third pair of ratio motors are positioned on a first side of the upright and wherein the second pair of ratio motors and the fourth pair of ratio motors are positioned on a second side of the upright, opposite to the first side.

13. The machine tool of claim 12, wherein a first main ratio motor belonging to the first or third pair of ratio motors is a master and the remaining three ratio motors of the first and third pairs of ratio motors are slaves, and wherein a second main ratio motor belonging to the second or fourth pair of ratio motors is a master and the remaining three ratio motors of the second and fourth pairs of ratio motors are slaves.

14. The machine tool of claim 10, wherein each upright translation member of the first and second pairs of upright translation members is a rack, and wherein each ratio motor of the four pairs of ratio motors comprises an upright translation electric motor having a motor axis parallel to the vertical direction and a gearbox having an inlet engaged with the upright translation electric motor, and an outlet engaged with the rack.

15. The machine tool of claim 6, wherein a gantry control is provided between the master and the slaves.

16. The machine tool of claim 1, wherein the working head is rotatable about a pitching axis and a rolling axis.

17. The machine tool according tool of claim 10, wherein the bench comprises a first pair of guides on which the upright slides, and wherein the rear support extends between a lower end connected to the bench, and an upper end, the second pair of upright translation members and a second guide on which the upright slides being positioned at said upper end.

18. The machine tool of claim 17, wherein at least a third guide fixed to the rear support and on which the upright slides is positioned between the upper end and the lower end.

19. The machine tool of claim 10, wherein both the first pair of upright translation members and the second pair of upright translation members extend along the longitudinal direction between a first end and a second end opposite to the first end, said first and second ends being associated with a position transducer, for example an optical ruler.

20. The machine tool of claim 13, wherein a gantry control is provided between the master and the slaves.
